(19) United States
(12) Patent Application Publication
(10) Pub. No.: US 2004/0163546 A1
(43) Pub. Date: Aug. 26, 2004

(54) Coffee machine provided with a device to cool the coffee with which it is loaded

(76) Inventors: Furio Suggi Liverani, Trieste (IT); Oriana Savonitti, Trieste (IT); Bruno Dellapietra, Trieste (IT); Stefano Cossetto, Trieste (IT); Roberto Cappuccio, Trieste (IT)

Correspondence Address: YOUNG & THOMPSON, 745 SOUTH 23RD STREET 2ND FLOOR, ARLINGTON, VA, 22202

(21) Appl. No.: 10/479,992

(22) PCT Filed: May 31, 2002
(86) PCT No.: PCT/EP02/05957

(30) Foreign Application Priority Data
Jun. 8, 2001 (IT) MI2001A001218

(51) Int. Cl. A47J 31/00

(52) U.S. Cl. 99/279

(57) ABSTRACT

A Peltier cell (8) is arranged with its cold part adjacent to the loading compartment of a coffee machine to cool the coffee contained therein; associated with this cell is a radiant place (15) and a first fan (14) to dissipate the heat generated by the hot part of the cell and likewise associated with it there may be a body (9) and a second fan (10) to facilitate the cooling of the air within the loading compartment.

The present invention concerns a coffee machine provided with a device to cool the coffee with which it is loaded.

The technical field of the invention involves the problem of maintaining the coffee loaded in a coffee machine at a temperature that will slow down the degeneration of the coffee before it is sent to the extraction chamber. Extraction chamber is here to be understood as the part of the coffee machine in which the drink is actually percolated.

By way of preliminary it should be clarified that, in accordance with the description, coffee loaded in a coffee machine is here to be understood as the coffee loaded into a compartment, situated in an appropriate part of said machine, in the form of loose toasted coffee beans or loose ground coffee or as individual packages of coffee that are commonly known as pods, capsules or cartridges. These packages contain one or more doses of ground coffee suitable for providing one or more cups of coffee. These packages, moreover, can either be single packages or contained—in a known manner—in a strip.

Said compartment is to be understood as any compartment, box or container suitable for containing loose toasted coffee beans, loose ground coffee or a quantity of said ground coffee packages either singly or in strips.

The pod is a dose of coffee compressed between two layers of water permeable paper through which water can permeate and generally presents itself in the form of a disk having a thickness of a few millimetres and surrounded by a crown consisting of the two layers of paper welded together; the capsule and the cartridge are doses contained in a wrapping that is generally of the form of a truncated cone or a cylinder or a disk made of plastic material or aluminium foil and becomes holed on the upper and lower walls when the capsule or cartridge is introduced into the extraction chamber, so that the water can pass through the coffee content.

As far as the applicant is aware, the prior art does not comprise a coffee machine provided with devices for cooling the coffee with which it is loaded and thus slowing down its decay.

The principal disadvantage of the known coffee machines is that the coffee with which they are loaded suffers from the nearness of the extraction chamber, which may be either permanently or occasionally hot, and the heater, which has a very high temperature. This causes a raising of the humidity content and the heating of the coffee loaded in the machine and therefore a more rapid decay of the coffee.

The machine in accordance with the present invention obviates the aforesaid disadvantage and, as characterized in the claims hereinbelow, comprises cooling means to actively cool the coffee loaded in a loading compartment and in the vicinity of the extraction chamber and means for dissipating the heat generated by said cooling means.

We speak of “actively cooling” the coffee in order to convey the idea that said means produce cold and are not simply means, like fans or similar devices, that keep the coffee fresh by ventilating it.

Said cooling means for actively cooling the coffee loaded in a coffee machine can be known and conventional refrigeration units, appropriately sized on the basis of the characteristics of each particular coffee machine, said machines comprising a thermally insulated compartment into which the coffee is loaded, while in a preferred embodiment of the coffee machine said cooling means comprise: at least one cooling element functioning on the basis of the Peltier effect and having a cold surface that is in contact with the interior of said compartment and a hot surface that is turned towards the outside; at least one radiant plate, situated outside said compartment, and at least one first fan to dissipate the heat generated by said cooling means outside the compartment or the coffee machine.

The Peltier effect is the phenomenon by virtue of which a direct current passing through the contact surface of two conductors of a different nature, for example the welded junction of two metal wires, which could be antimony and bismuth or tellurium and bismuth, will give rise to the evolution or absorption of heat at said contact surface according to the direction in which the current is passing.

Elements—generally in the form of plates or cells—that realize the Peltier effect to the desired extent defined by appropriate technical specifications can be obtained from industry. For the sake of simplicity, in the description about to be given the cooling element of the preferred embodiment will be referred to as a Peltier cell.

In the preferred embodiment said radiant plate absorbs heat by conduction from the hot surface of said Peltier cell and dissipates it outside the compartment, said radiant plate being cooled by said first fan.

The preferred embodiment may also comprise at least one cold body extending from the cold surface of Peltier cell to facilitate the cooling of the air contained therein. Said cold body is conventionally called by this name since, being in contact with the cold surface of the Peltier cell, it always remains cold.

Furthermore, at least one second fan may be associated with said cold body to facilitate the circulation of the air cooled by said cold body within said compartment.

The advantage of the machine in accordance with the present invention is that, maintaining the coffee within the coffee machine at a low temperature, the decay of the product is slowed down, thus obtaining a better conservation of the organolectic characteristics of the product to be extracted and therefore also a better quality of the product after the percolation.

In fact, the applicant has carried out comparative tests of the instrumental and the organolectic type to verify the difference between the aromatic charge present in the coffee in a prior art machine and in a machine in accordance with the present invention, noting that in the latter case the loaded coffee may remain for a longer period of time without any substantial loss of aromatic charge.

It will readily be understood that the temperature within the loading compartment will depend on the following characteristics:

size of the coffee container and the material from which it is made;

size and position of the cooling element;

quantity of the cooling elements employed;

type of insulating material employed;

insulation modality;

quantity and size of said cooling body and said radiant plate.

The invention will now be described in greater detail by reference to a number of embodiments and with the help of schematic drawings of which:

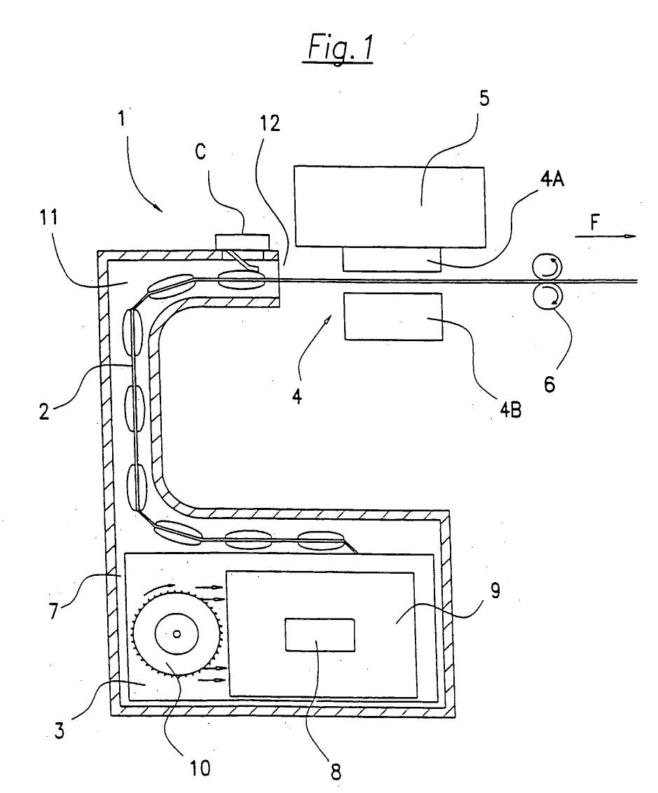

FIG. 1 is a first vertical cross-section view;

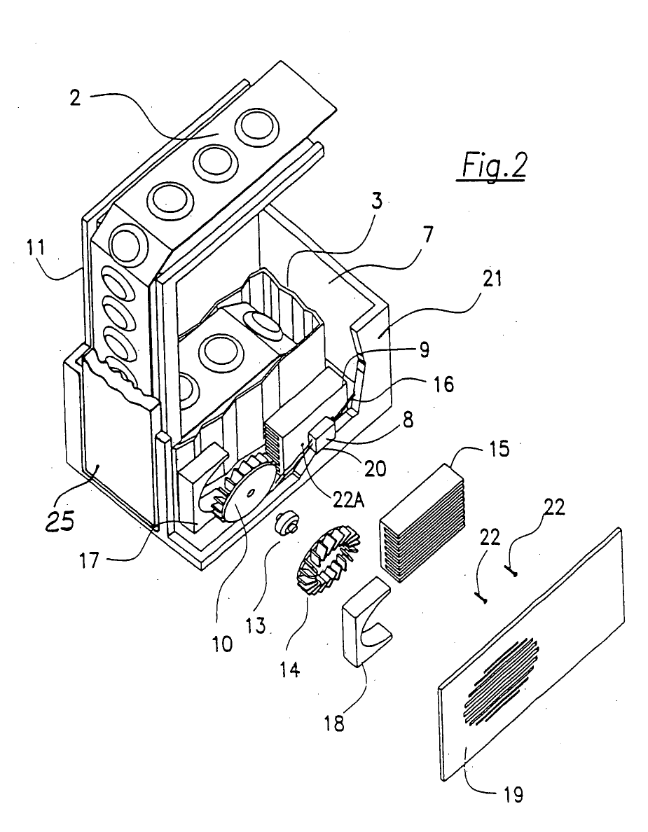

FIG. 2 is a first partially exploded view;

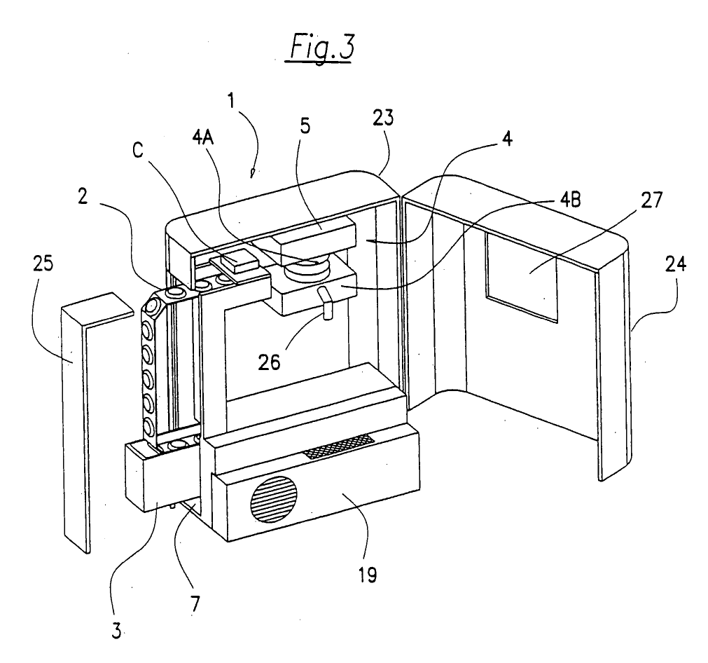

FIG. 3 is a vertical perspective view;

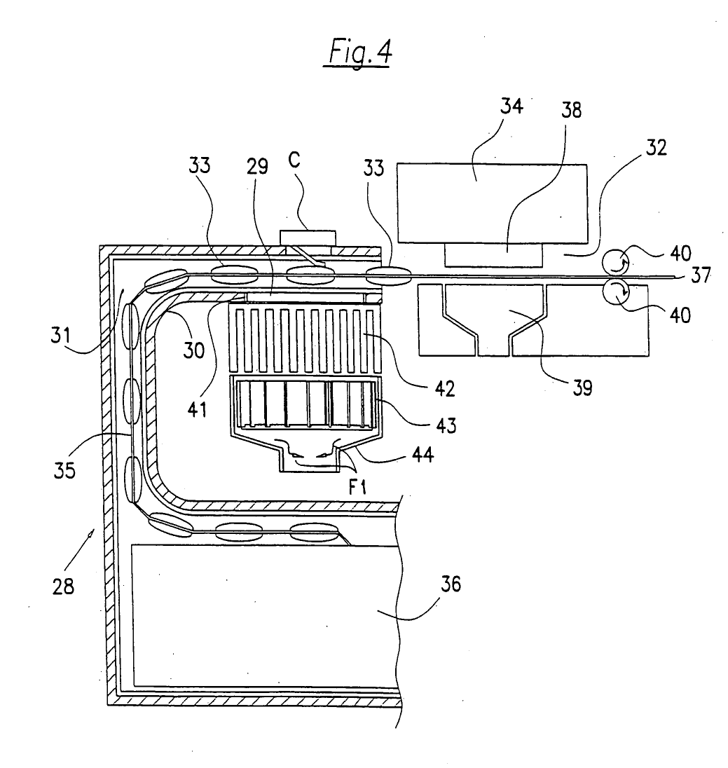

FIG. 4 is a second vertical cross-section view; and

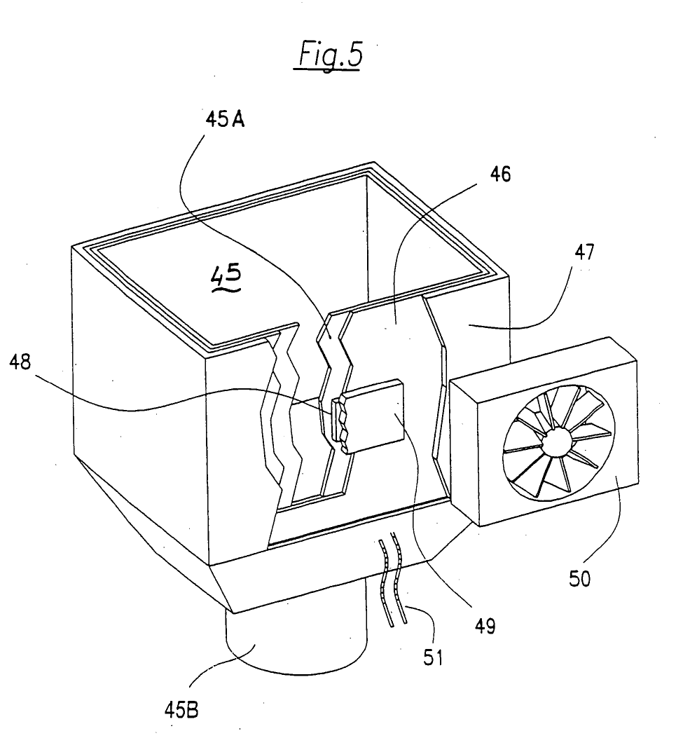

FIG. 5 is a third vertical cross-section view.

FIG. 1 shows the essential parts of a coffee machine 1. The reference number 2 indicates a conventional strip of pods; 3 indicates a conventional container of the strip of pods 2; 4 indicates a conventional extraction chamber in which 4A and 4B are, respectively, the fixed head and the mobile head; C indicates a conventional pod counter; 5 indicates a conventional heat exchanger capable of instantaneously heating the water contained in a receptacle not shown on the drawing and 6 indicates conventional wheels for dragging the pod strip. Furthermore, the figure shows a loading chamber 7 of the container 3 of the pod strip 2, a Peltier cell 8, a finned cold body 9 and a fan 10 outside the container 3 to cool the environment of compartment 7 and therefore also the coffee, the details of which will be explained with reference to the subsequent figures. Said loading compartment 7 contains the container 3 of the pod strip 2 and extends into a kind of duct 11 having the form of an upside-down “L” that terminates adjacent to said extraction chamber 4. An operator initially pulls the end of pod strip 2 out of the container and passes it through said duct 11 until it projects from the duct's open end 12 adjacent to the extraction chamber, eventually engaging it with the dragging wheels 6. When the machine is in operation, the dragging wheels—in a known manner—will cause the strip to advance in the direction of the arrow F until a pod of the strip becomes positioned in the extraction chamber, at this point the mobile head 4B is made to rise until it comes to butt against the fixed head 4A to permit the percolation of the drink.

FIG. 2 shows the pod strip 2 partially contained in its container 3 within the loading compartment 7 and inserted in duct 11 (defined by the wall element 25, a part of which can be seen in the figure) with its end already projecting from the duct. This figure shows the details of the Peltier cell 8, the cold body 9 and the fan 10 already shown in FIG. 1. The figure also shows (as an exploded view for better comprehension) a second fan 14 coaxial with fan 10, a radiant plate 15, an electric motor 13 to operate said fans 10 and 14, supply cables 16 of the Peltier cell and the electric motor, the semi-guard-rings 17 and 18 of said fans and a gridded protection mask 19. The Peltier cell 8 is housed in an appropriate opening 20 of the wall 21 and in such a way that its cold surface will be within the compartment and its hot surface outside thereof. The cold body 9 is attached to said cold surface of the Peltier cell 8 so that with its fins it will form a cold extension inside the compartment 7; the radiant plate 15 is fixed to the hot surface of said cell to absorb the heat and dissipate it outside the compartment and is fixed to the cold body 9 by means of the screws 22 that engage with the holes 22A via through holes in the wall 21 that are not shown in the figure. The fan 10 causes air to circulate inside the compartment 7, said air thus becoming cooled in contact with the cold body 9 and distributed throughout the compartment and also along of the duct 11 to maintain all the pods of the strip at a low temperature, including those close to the extraction chamber 4 (not shown). Fan 14 gathers the air from outside compartment 7 and sends it onto the radiant plate 15, thus cooling the latter and facilitating the heat dissipation.

It will be understood that compartment 7 will be appropriately protected by insulating material that for simplicity of representation is not shown in the figure.

The various parts in FIG. 3 are indicated by the same reference numbers that the corresponding parts bear in the previous figures. FIG. 3 provides a schematic view of the coffee machine 1 of FIG. 1 inserted in its casing 23. The front door 24 is open and the wall element 25 that defines the duct of compartment 7 is shown detached from its actual position. The container 3 is shown not yet completely inserted in the loading compartment 7 and one of the ends of the pod strip 2 is already pulled out to a position adjacent to the extraction chamber, ready to be engaged with the dragging wheels (not shown in the figure). In this figure the Peltier cell, the cold body, the radiant plate, the fans, the electric motor and the semi-guard-rings (all shown in FIG. 2) are in their respective working positions and covered by the gridded protection mask 19. The figure also shows a nozzle 26 associated with the mobile head 4B of the extraction chamber, said nozzle projecting through the opening 27 of the front door 24 to provide the drink.

FIG. 4 shows part of a coffee machine 28 altogether similar to the one shown in the previous figures, but in which the Peltier cell 29 is associated with the lower wall 30 of the upper end of the duct 31 adjacent to the extraction chamber 32 to maintain at a low temperature the pods 33 closest to the extraction chamber 32 and therefore also the heat exchanger 34. The end 37 of the pod strip is engaged with the dragging wheels 40 as explained in FIG. 1. The Peltier cell 29 is housed in an opening 41 of said wall 30 in such a way that its cold surface is inside the duct 31 and its hot surface outside thereof. A radiant plate 42 is associated with the hot surface of said cell to dissipate the heat outside the duct. A cooling fan 43 removes the heat from the radiant plate to send it—in the direction of the arrows F1—to the outside of the distributor by means of the duct 44.

FIG. 5 shows a loading compartment 45 for loose ground coffee or loose coffee beans (the coffee not being shown in the figure) that by means of the duct 45B is associated in a known manner with the upper part of a coffee machine below said compartment, the machine being likewise not shown in the figure. The wall 45A of said compartment 45 is lined by a layer of heat-conducting material 46 and a layer of insulating material 47. Furthermore, the reference number 48 indicates a Peltier cell, 49 indicates a radiant plate and 50 a cooling fan. The cold surface of the Peltier cell 48 is in contact with said layer of heat-conducting material 46 to maintain the coffee contained in said compartment 45 at a low temperature. Associated with the hot surface of the Peltier cell there is the radiant plate 49 and said cooling fan 50 (which in the figure is shown away from its working position) is mounted adjacent to the radiant plate in order to facilitate the heat dissipation. The figure also shows the cables 51 that feed said Peltier cell as passing under the layer of heat conducting material 46.

1. Coffee machine (1, 28) provided with a device for cooling the coffee with which it is loaded, where the coffee may be in the form of individual packages or package strips or in the form of loose ground, coffee or loose coffee beans and is loaded in a loading compartment (7, 45) and adjacent to the extraction chamber (4, 32), characterized in that it comprises cooling means (8, 29, 48) to actively cool the loaded coffee and means (14, 43, 50-15, 42, 49) to dissipate the heat generated by said cooling means.

2. Coffee machine in accordance with claim 1, characterized in that said cooling means are one or more refrigerating units.

3. Coffee machine in accordance with claim 1, characterized in that said cooling means are at least one Peltier cell (8, 29, 48) of which the cold surface is in contact with the interior of the loading compartment (7, 45) and the duct (31) and the hot surface is turned towards the outside of said loading compartment and duct.

4. Coffee machine in accordance with claim 3, characterized in that said Peltier cell (8, 29, 48) has associated with it at least one radiant plate (15, 42, 49) outside the loading compartment, said plate having associated with it at least one first fan (14, 43, 50) to dissipate the heat outside said loading compartment.

5. Coffee machine in accordance with claims 3 and 4, characterized in that said Peltier cell (8, 29, 48) has associated with it at least one cold body (9) that extends from the cold surface of said cell (8, 29, 48) to inside the loading compartment (7) to facilitate the cooling of the air inside the compartment.

6. Coffee machine in accordance with claim 5, characterized in that a fan (10) facilitates the circulation inside the loading compartment of the air cooled by said cold body.
